(19) United States
(12) Patent Application Publication
(10) Pub. No.: US 2012/0237715 A1
(43) Pub. Date: Sep. 20, 2012

(54) BENDING PREFORMED VACUUM INSULATION PANEL

(75) Inventor: Ivan A. McCracken, Portland, OR (US)

(73) Assignee: XEROX CORPORATION, NORWALK, CT (US)

(21) Appl. No.: 13/049,955

(22) Filed: Mar. 17, 2011

(51) Int. Cl. B32B 3/30; B29C 53/06

(52) U.S. Cl. 428/69; 264/295

(57) ABSTRACT

Methods alter the shape of vacuum insulation panels in processes that begin by supplying a previously manufactured vacuum insulation panel. Such a vacuum insulation panel comprises a continuous porous core material surrounded by a sealed airtight cover that is formed in a process such that the sealed airtight cover keeps the pressure level within the vacuum insulation panel below the ambient atmospheric pressure (maintains a vacuum with the vacuum insulation panel). The methods herein form at least one indent into the exterior of the vacuum insulation panel and into the surface of the continuous porous core material, without piercing the sealed airtight cover. After forming such an indent, the methods herein fold the vacuum insulation panel along the indent.

### BACKGROUND

Embodiments herein generally relate to vacuum insulation panels and more particularly to methods and devices that bend and fold preformed vacuum insulation panels without breaking the vacuum of the vacuum insulation panels.

It is often necessary to thermally insulate certain device, either to keep devices cold, keep devices hot, or to protect devices from other elements that may be cold or hot. For example, solid ink (SI) printers make use of a phase-change ink, which should be melted and remain at an elevated temperature in order to accomplish the print process.

In an effort to meet green initiatives and retain energy-related certifications, many advances are directed toward technology for reducing the power usage of such printers. In the past, heated components, or subsystems, within a printer have generally been insulated with plastic parts, making use of trapped air to decrease heat loss. Vacuum insulation panels (Mica sheet and polymeric foam) in combination with plastic have each also been used to reduce power loss, reference for example U.S. Patent Publication Number 2009/0273657, the complete disclosure of which is incorporated herein by reference.

### SUMMARY

Various exemplary methods herein alter the shape of vacuum insulation panels in processes that begin by supplying a previously manufactured vacuum insulation panel. Such a vacuum insulation panel comprises a porous core material surrounded by a sealed airtight cover that is formed in a process such that the sealed airtight cover keeps the pressure level within the vacuum insulation panel below ambient atmospheric pressure (maintains a vacuum with the vacuum insulation panel). The methods herein form at least one indent into the exterior of the vacuum insulation panel and into the surface of the continuous porous core material, without piercing the sealed airtight cover (and without breaking the vacuum within the vacuum insulation panel). After forming such an indent, the methods herein fold the vacuum insulation panel along the indent.

The process of forming the indent presses down on the continuous porous core material and deforms the otherwise linear surface of the porous core material, and thereby changes the shape of the continuous porous core material. For example, the process of forming the indent can comprise embossing the exterior of the vacuum insulation panel using a die. Further, the process of forming the indent forms a linear indent along the length or width of the vacuum insulation panel and can form, for example, a V-shaped indent into the exterior of the vacuum insulation panel.

The process of folding the vacuum insulation panel along the indent can be performed using a number of different methods. For example, the folding process can be accomplished by supporting the top and the bottom of the vacuum insulation panel and applying force to the indent. Alternatively, the fold can be made by supporting the bottom of the vacuum insulation panel and forcing a region of the vacuum insulation panel on one side of the indent toward another side of the vacuum insulation panel (on a different side of the indent). Additionally, this folding can align the indent with a corner of a mold and fold the vacuum insulation panel around the mold.

Embodiments herein also comprise a vacuum insulation panel produced by the foregoing methods. Such a vacuum insulation panel includes a porous core material, a sealed airtight cover surrounding the porous core material, at least one indent in the sealed airtight cover and extending into the porous core material (without piercing the sealed airtight cover), and a fold in the vacuum insulation panel along the indent. Again, the sealed airtight cover keeps the pressure level within the vacuum insulation panel below ambient atmospheric pressure.

This disclosure presents a method of forming and bending a vacuum panel (VP). For purposes of this disclosure, a vacuum panel is defined as a composite sheet consisting of a core encompassed by a layer, or layers, which enable the creation of an internal vacuum. The methods herein first create a bend-enabling linear impression in the VP core material and secondly bend the panel at the location of the impression such that a planar region becomes two planes.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a side-view schematic diagram of a device according to embodiments herein;

FIG. 2 is a side-view schematic diagram of a device according to embodiments herein;

FIG. 3 is a perspective-view schematic diagram of a device according to embodiments herein;

FIG. 4 is a side-view schematic diagram of a device according to embodiments herein;

FIG. 5 is a side-view schematic diagram of a device according to embodiments herein;

FIGS. 6A and 6B are side-view schematic diagrams of a device according to embodiments herein;

FIG. 7 is a side-view schematic diagram of a device according to embodiments herein;

FIG. 8 is a perspective-view schematic diagram of a device according to embodiments herein;

FIG. 9 is a perspective-view schematic diagram of a device according to embodiments herein;

FIG. 10 is a side-view schematic diagram of a device according to embodiments herein;

FIG. 11 is a side-view schematic diagram of a device according to embodiments herein; and

FIG. 12 is a side-view schematic diagram of a device according to embodiments herein.

### DETAILED DESCRIPTION

The embodiments herein provide methods for forming and bending a vacuum panel (VP) that is often called a vacuum insulation panel (VIP). Vacuum insulation panels are made by sealing a thermal insulation core in a barrier film under vacuum. The inner structure or insulation core may be a honeycomb-like polymeric material (commonly Instill, available from Dow Chemical Co., Midland, Mich., USA) of varying thickness with overlay or envelope, typically metalized polyester (Mylar available from CS Hyde Co., Lakevilla, Ill., USA), that is sealed and will maintain a vacuum created during the panel assembly. The more expensive and higher insulation rated panels use some form of Aerogel (available from Aspen Aerogels Co., Northborough, Mass., USA) as the core. The vacuum insulation panels are illustrated in the drawings as being rectangular; however, those ordinarily skilled in the art would understand that the panels could take any shape including, but not limited to, cube-shaped, rounded, sphere-shaped, planar, etc.

Any alteration of the panel form can damage or degrade the vacuum seal maintained by the barrier film. Therefore, panels are typically produced and maintained in a flat condition. “Box” like shapes are produced by bonding multiple panels; however, this can create many thermal conduction paths to the ambient environment. The bending produced by embodiments herein avoids such thermal conduction paths.

Vacuum panels constructed for the purpose of insulation can exhibit thermal conductivity values as low as ˜0.004 W/m-K, neglecting edge effects of the packaging material which is required to achieve vacuum. An insulating wrap (multiple surfaces) improperly configured can quickly negate the thermal conductivity advantage of a vacuum panel. Panel ends or connective “ribs” provide conductive paths and are to be avoided. Minimizing the number panel edges reduces heat loss, as the external panel layer (packaging material) has a higher thermal conductivity than the core material.

To achieve optimal insulation benefits the embodiments herein bend a continuous panel (rather than section it into discrete parts as is done conventionally) in order to surround a heated body with a low thermal conductivity material.

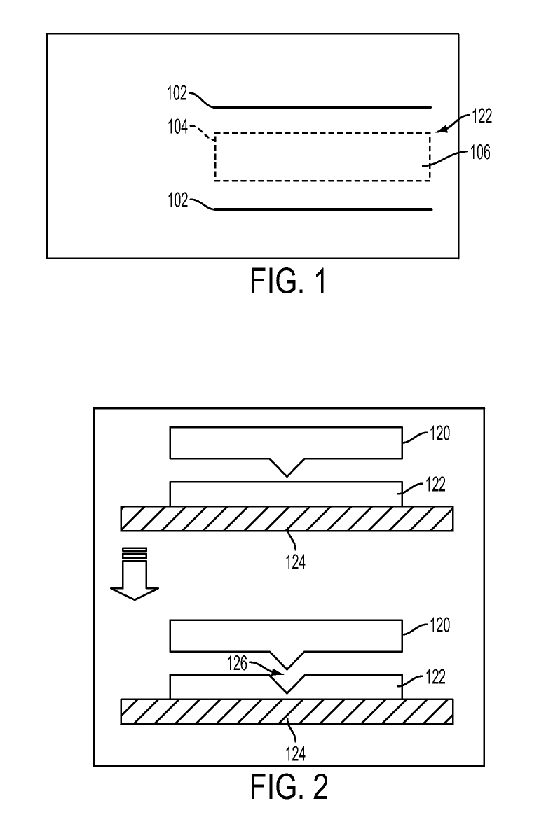

Various exemplary methods herein alter the shape of vacuum insulation panels in processes that begin by supplying a previously manufactured vacuum insulation panel 122. In FIG. 1, such a vacuum insulation panel 122 comprises a continuous porous core material 106 surrounded by a sealed airtight cover that is formed in a process such that the sealed airtight cover 102, 104 maintains a vacuum. The cover 102, 104 can comprise a core containment bag 104 and a multi-layer vacuum bag 102 and is simply referred to as a cover 102 hereafter.

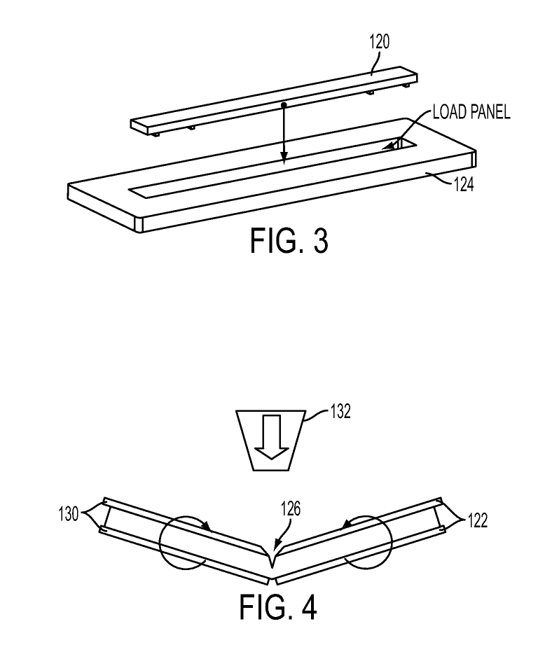

The cover 102 keeps the pressure level within the vacuum insulation panel 122 below ambient atmospheric pressure (maintains a partial or full vacuum with the vacuum insulation panel 122). As shown in FIGS. 2 and 3, the methods herein form at least one indent into the exterior of the vacuum insulation panel 122 and into the surface of the continuous porous core material 106, without piercing the sealed airtight cover 102 (and without breaking the vacuum within the vacuum insulation panel 122).

It can appreciated that the insulating efficacy of the vacuum panel 122 is directly related to the permeability of the packaging bag 102, and therefore it is best not to stress the packaging 102 in a way that would reduce its integrity and ultimately result in an increase in internal pressure (loss vacuum). For example, the process of forming the indent 126 can comprise embossing the exterior of the vacuum insulation panel 122 using a die 120. It is desirable to constrain the core along the sides and bottom so as to limit unintended deformation of the core and encourage retention in shape.

Further, the process of forming the indent 126 forms a linear indent 126 along the length or width of the vacuum insulation panel 122 and can form, for example, a V-shaped indent 126 into the exterior of the vacuum insulation panel 122, as shown in FIG. 3. For reasons of fit and function the location of the bend(s) on the vacuum panel 122 should be accurate. Using a base 124, as seen in FIG. 3, with features to locate the vacuum panel 122 and an embossing die 120 with respect to each other results in an accurate and repeatable means of locating the bend line 126 on the panel 122.

After forming such an indent 126, the methods herein fold the vacuum insulation panel 122 along the indent as shown in FIGS. 4-8. The process of folding the vacuum insulation panel 122 along the indent 126 can be performed using a number of different methods, none of which break the vacuum within the cover 102.

For example, as shown in FIG. 4, the folding process can be accomplished by supporting the top and the bottom of the vacuum insulation panel 122 using support surfaces 130 and applying force using an actuating plunger 132 to the indent 126.

In the folding process shown in FIG. 4, first the panel 122 should be supported on either side of the bend line (indent 126) on both the top and bottom surfaces of the panel 122. Not doing so may result in unintended deformation and/or vacuum rupture. Second, the panel 122 should slide freely at the interface with the supports 130 such that the panel 122 surface is not stretched or compressed during the bending operation. Third, support pairs 130 on either side of the bend line should remain parallel during the bending operation.

The bending operation shown in FIG. 4 can be assisted by rotating one or both of the support pairs 130 about the axis of the bend line 126. The rotation of the support pairs can be linked such that the pairs move in unison, and the rotation movement can be accomplished directly, where action is applied to the pair(s), or indirectly, where a plunger (for example) would interact with the support pairs causing them to rotate.

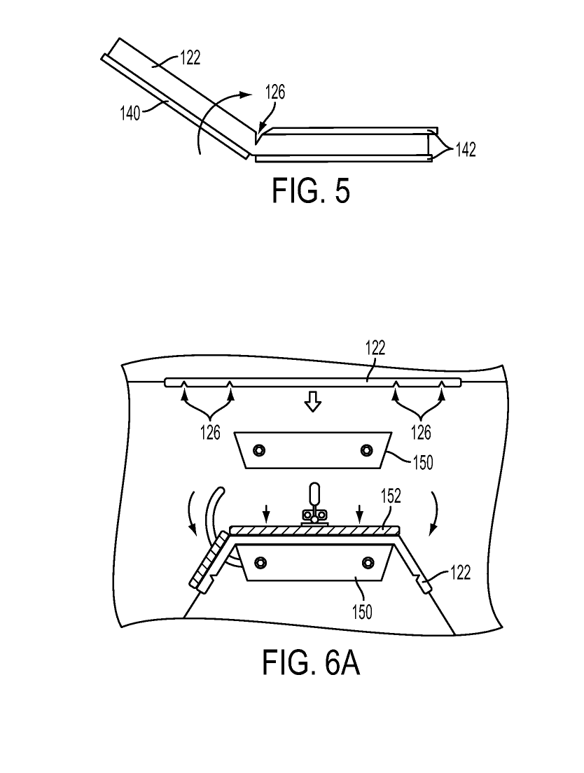

Alternatively, as shown in FIG. 5, the fold can be made by supporting the bottom of the vacuum insulation panel 122 and forcing a region of the vacuum insulation panel 122 on one side of the indent 126 (using side one support 140) toward another side of the vacuum insulation panel 122 (on a different side of the indent 126) that is supported by side to supports 142. The panel 122 is supported on the bottom surface on either side of the bend line 126 and on the top and bottom surfaces on one side of the bend line (side two 142 for example). Side two supports 142 are used to hold the panel 122 stationary, and the side-one support 140 is rotated about the bend line 126 to accomplish the bend in the panel 122. The panel 122 should slide freely against the support on side one 140.

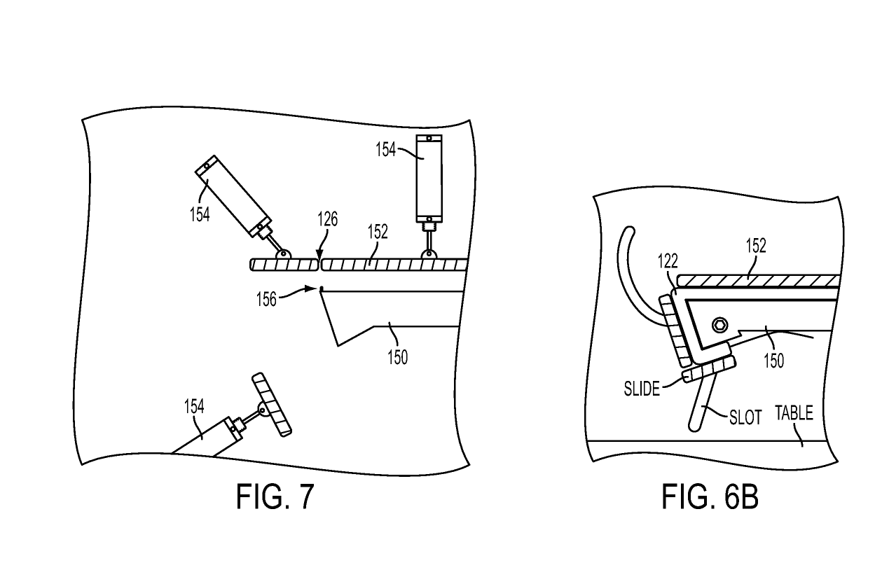

Alternatively, as shown in FIGS. 6A, 6B, and 7, this folding can align the indent 126 with a corner of a mold 150 and fold the vacuum insulation panel 122 around the mold 150 using flat pressing elements 152. The pressing elements can be moved by some form of actuator 154, such as air cylinder pistons to fold the vacuum insulation panel 122 around the corners of the mold 150.

Therefore, this embodiment utilizes one or more of the bend lines 126 to automatically position the vacuum insulation panel 122 in the proper location with respect to the mold 150 and the pressing elements 152. This results in increased dimensional control, as it can be appreciated that the panel 122 could be distorted in the general region of the bend impression, resulting in a small shift of location for the bend.

In addition, if desired, the mold 150 can include one or more locating components, shown as a bump 156, which stands out of the support surface 150. Additionally, the locating component 156 can be otherwise positioned at a fixed distance along the plane of the support surface 150 such that the panel 122 can be located when the bump 156 fits into the bend impression 126. The locating bump 156 could be independent of the support surface 150 and located on a different element.

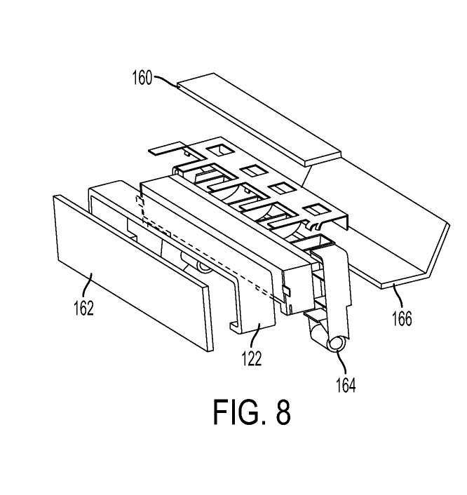

In one exemplary embodiment, the method and structure mentioned herein can be utilized to insulate a printhead 164, as illustrated in FIG. 8. More specifically, as shown in FIG. 8, a bent vacuum insulation panel 122 as described above is used to surround and thermally insulate the print head 164 to keep the printhead at a proper operating temperature. Element 166 is also a bent vacuum panel. If desired both bent vacuum insulation panels 122, 166 can be permanently attached to the printhead 164. Elements 160 and 162 are flat (unbent) vacuum insulation panels and can be moved into place during non-printing modes.

The process of forming the indent 126 presses down on the continuous porous core material 106 and deforms the otherwise linear surface of the porous core material 106, and thereby changes the shape of the continuous porous core material 106.

Such a vacuum insulation panel 122, therefore, includes a porous core material 106, a sealed airtight cover 102 surrounding the porous core material 106, at least one indent 126 in the sealed airtight cover 102 and extending toward the porous core material 106 (without piercing the sealed airtight cover 102), and a fold in the vacuum insulation panel 122 along the indent 126. Again, the sealed airtight cover 102 keeps the pressure level within the vacuum insulation panel 122 below ambient atmospheric pressure.

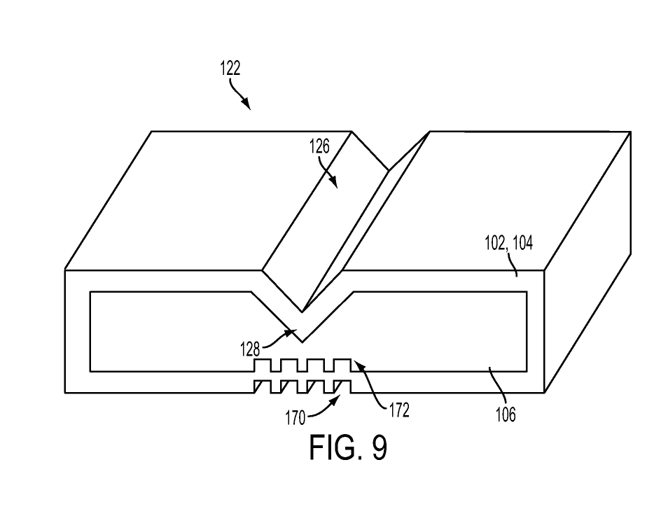

FIG. 9 illustrates a cutaway perspective view of one example of the vacuum insulation panel 122. This cutaway view illustrates the core 106 and the cover 102, 104 that surrounds the core 106 and that maintains a vacuum within the core 106. As shown in FIG. 9, the cover 102, 104 includes an indent 126 that can be viewed from outside the vacuum insulation panel 122. This indent 126 can run along the length or width (fully or partially) of the vacuum insulation panel 122.

In addition, the pressure exerted on the cover 102, 104 in order to create the indent 126 can also form a second indent 128 within the core material 106 itself. In other words, the pressure exerted by the die 120 can crush some of the core material 106 to create the second indent 128. This second indent 128 is located adjacent the first indent 126 in the sealed airtight cover 102. Thus, in such a structure the porous core material 106 comprises a continuous porous core material 106 interrupted only by the one or more indents 128.

Further, and in order to limit potential stress to a fragile cover, the embodiments herein can create regions 170 of increased cover material in the area local to the embossed feature. This can be done by texturing the core material 172 to the extent that the cover is drawn down over this texture during evacuation of the panel, thereby increasing the amount of cover material 170 in the textured area 172, as the cover is drawn down over the peaks and valleys of the textured area 172.

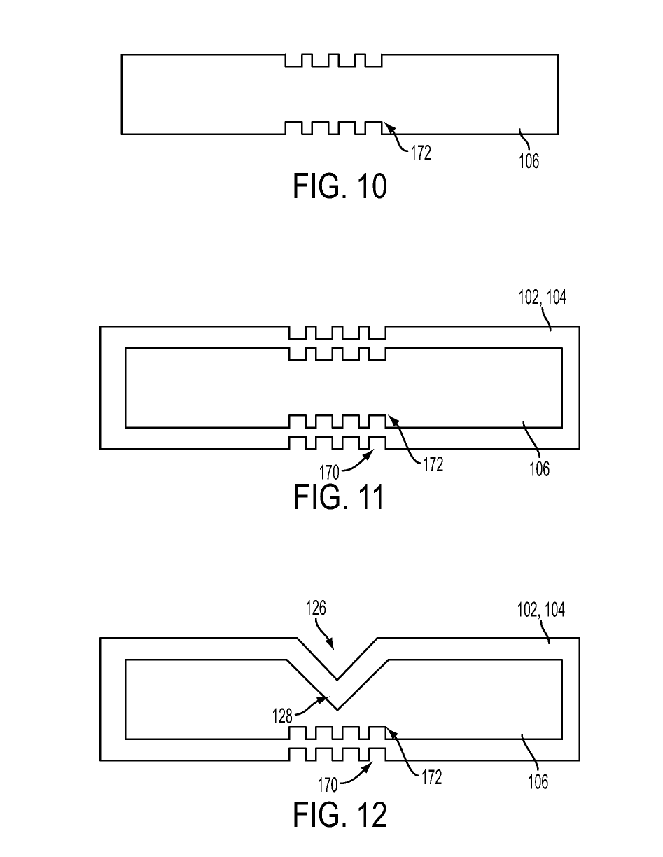

As shown in FIGS. 10-12, the structure shown in FIG. 9 is formed by first patterning texture recesses into the core material 172 (FIG. 10). Next, the conformal cover material 172 takes the shape of the textured region of the core material 170 as the cover material 172 is formed over the core material 170 (FIG. 11). Then, the first and second indents 126, 128 are simultaneously formed (as shown above) in the core and cover materials 170, 172.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A method comprising:
supplying a vacuum insulation panel, said vacuum insulation panel comprising a porous core material surrounded by a sealed airtight cover, said sealed airtight cover keeping a pressure level within said vacuum insulation panel below ambient atmospheric pressure;
forming at least one indent into an exterior of said vacuum insulation panel without piercing said sealed airtight cover; and
folding said vacuum insulation panel along said indent.

2. The method according to claim 1, said forming of said indent changing the shape of said porous core material.

3. The method according to claim 1, said forming of said indent comprising forming a linear indent along one of a length and a width of said vacuum insulation panel.

4. The method according to claim 1, said forming of said indent comprising forming a V-shaped indent into said exterior of said vacuum insulation panel.

5. The method according to claim 1, said forming of said indent comprising embossing said exterior of said vacuum insulation panel using a die.

6. A method comprising:
supplying a previously manufactured vacuum insulation panel, said vacuum insulation panel comprising a continuous porous core material surrounded by a sealed airtight cover, said sealed airtight cover keeping a pressure level within said vacuum insulation panel below ambient atmospheric pressure;
forming at least one indent into an exterior of said vacuum insulation panel and into a surface of said continuous porous core material without piercing said sealed airtight cover; and
folding said vacuum insulation panel along said indent.

7. The method according to claim 6, said forming of said indent changing the shape of said continuous porous core material.

8. The method according to claim 6, said forming of said indent comprising forming a linear indent along one of a length and a width of said vacuum insulation panel.

9. The method according to claim 6, said forming of said indent comprising forming a V-shaped indent into said exterior of said vacuum insulation panel.

10. The method according to claim 6, said forming of said indent comprising embossing said exterior of said vacuum insulation panel using a die.

11. A method comprising:
supplying a previously manufactured vacuum insulation panel, said vacuum insulation panel comprising a porous core material surrounded by a sealed airtight cover, said sealed airtight cover keeping a pressure level within said vacuum insulation panel below ambient atmospheric pressure;
forming at least one indent into an exterior of said vacuum insulation panel without piercing said sealed airtight cover; and
folding said vacuum insulation panel along said indent by one of:
supporting a top and a bottom of said vacuum insulation panel and applying force to said indent;
supporting said bottom of the vacuum insulation panel and forcing a region of said vacuum insulation panel on one side of said indent toward another side of said vacuum insulation panel on a different side of said indent; and
aligning said indent with a corner of a mold and folding said vacuum insulation panel around said mold.

12. The method according to claim 11, said forming of said indent changing the shape of said porous core material.

13. The method according to claim 11, said forming of said indent comprising forming a linear indent along one of a length and a width of said vacuum insulation panel.

14. The method according to claim 11, said forming of said indent comprising forming a V-shaped indent into said exterior of said vacuum insulation panel.

15. The method according to claim 11, said forming of said indent comprising embossing said exterior of said vacuum insulation panel using a die.

16. A vacuum insulation panel comprising:
a porous core material;
a sealed airtight cover surrounding said porous core material, said sealed airtight cover keeping a pressure level within said vacuum insulation panel below ambient atmospheric pressure;
at least one indent in said sealed airtight cover and extending toward said porous core material without piercing said sealed airtight cover; and
a fold in said vacuum insulation panel along said indent.

17. The vacuum insulation panel according to claim 16, further comprising a second indent within said porous core material, said second indent being located adjacent said indent in said sealed airtight cover.

18. The vacuum insulation panel according to claim 16, said indent comprising a linear indent along one of a length and a width of said vacuum insulation panel.

19. The vacuum insulation panel according to claim 16, said indent comprising a V-shaped indent.

20. The vacuum insulation panel according to claim 16, said porous core material comprising a continuous porous core material interrupted only by said at least one indent.
